(19) United States
(12) Patent Application Publication
(10) Pub. No.: US 2016/0227937 A1
(43) Pub. Date: Aug. 11, 2016

(54) ARRANGEMENT FOR USE OF A FUNCTIONAL SEAT

(71) Applicant: TAMERGO OY, Tampere (FI)

(72) Inventors: Jorma EEROLA, Tampere (FI); Teemu HÄRKÖNEN, Tampere (FI); Mikko KIVEKÄS, Helsinki (FI); Ismo KYTÖVIITA, Tampere (FI); Petri PALO-OJA, Tampere (FI)

(21) Appl. No.: 15/022,624

(22) PCT Filed: Sep. 15, 2014
(86) PCT No.: PCT/FI2014/050701

§ 371 Date: Mar. 17, 2016

(30) Foreign Application Priority Data
Sep. 17, 2013 (FI) 20135933

(51) Int. Cl. A47C 7/56; A61G 5/14; A47C 7/60

(52) U.S. Cl. CPC A47C 7/56; A47C 7/60; A61G 5/14

(57) ABSTRACT

The invention relates to an arrangement for use of a functional seat, which seat is intended particularly for assisting a person sitting thereon to stand up from a sitting position. The arrangement comprises a seat part (1) provided/to be provided in connection with a sitting base (A) and being coupled in a power transmitting manner with armrests (1a) of the seat, wherein the seat part (1) is arranged by a movement mechanism (x) simultaneously on the other hand to incline from an essentially horizontal sitting-position (I) to a standing up-position (II), where the seat part is inclined down ward toward its front edge, and on the other hand to move upward while being inclined to the standing up-position (II) from the sitting-position (I) particularly in order to enable assisting a standing up-movement, advantageously by influence of the person him-/herself sitting on the seat part (1), by exploiting his/her upper body through using hand force. The arrangement comprises driving means (y), including at least a locking assembly (y1) for an locking the seat essentially immovably to its sitting-position (I) and a releasing assembly (y2) for reinstating the movement function of the seat by releasing it from its sitting-position (I), wherein releasing assembly (y; y2) of the driving means is arranged to operate by influence of the power directed to the seat part (1) from the person sitting on the seat, in order to activate the movement function of the seat automatically when the person is sitting on the seat.

The invention relates to an arrangement for use of a functional seat, which seat is intended particularly for assisting a person sitting thereon to stand up from a sitting position. The arrangement comprises a seat part provided/to be provided in connection with a sitting base and being coupled in a power transmitting manner with armrests of the seat. The seat part is arranged by a movement mechanism simultaneously on the one hand to incline from an essentially horizontal sitting-position to a standing up-position, where the seat part is inclined downward toward its front edge, and on the other hand to move upward while being inclined to the standing up-position from the sitting-position particularly in order to enable assisting a standing up-movement, advantageously by influence of the person him-/herself sitting on the seat part, by exploiting his/her upper body through using hand force. The arrangement comprises at least partly independently functional driving means, operating by power that is directed to the seat part from the person sitting on the seat, the driving means comprising at least a locking assembly for locking the seat essentially immovably to its sitting-position and a releasing assembly for reinstating the movement function of the seat by releasing it from its sitting-position.

The purpose of the seat arrangement is particularly to further standing up in an assisted manner of a person sitting on a sitting base so that the person him-/herself could be able to stand up without an assistant.

Today there is on the market e.g. a shower wheelchair developed for the above purpose, in which the armrests are arranged to incline together with the seat surface into a downward tilting position by its front edge. To assist the tilting movement in the solution in question and in order to diminish use of power required of the person sitting on the seat surface, the seat surface is coupled in a spring operated manner with the support structures of the chair. The showerchair in question is thus in its standby-position inclined downward by its seat surface, in which case the person standing in front of the wheelchair with his back facing the wheelchair first of all starts to lean on the seat surface and thereafter, when getting lower while sitting down, presses the seat surface into a horizontal position by influence of his/her weight. When the person stands up from the chair, the spring force assists the person to stand up from the seat surface.

The solution in question is in principle a step in the right direction, but it is not, however, easy enough to use in practice, so that e.g. a person having limited capability for moving or an aged person could manage totally by him-/herself to deal with his/her activities only with the help of it. Furthermore a disadvantage involved with a spring powered implementation is the fact that it requires adjustment of the spring force according to the weight of a person at any given time, so that a too high spring force will make it difficult for a person to sit down or on the other hand that the influence of the spring power will remain inadequate due to high weight of a person. Generally taken, a big problem in the implementation of the type in question is furthermore the fact that from the point of view of the person using the chair in question, the chair offers only passive assistance, so that use of power of the person him-/herself can not be activated.

On the other hand, from patent publication FI 850635, a developed armchair is further known, which comprises a seat part with armrests, whereby in connection with the seat part is arranged a joint mechanism in order to incline the seat part from an essentially horizontal sitting-position to a standing up-position, where the seat part is inclined downward toward its front edge, and to move the seat part upward while being inclined to the standing up-position from the sitting-position. In order to enable assisting of a standing up-movement by influence of the person him-/herself sitting on the seat part, by exploting his/her upper body through using hand force, the joint mechanism is arranged operable by a power influence directed downward from the armrests.

The solution mentioned above is based on a very complicated and multi-part joint mechanism, being carried out on scissors-principle, whereby one articulation point is movable with respect to the frame of the chair due to the scissors-principle. The solution in question is thus expensive to carry out due to the multitude of articulated arms and articulation points of the joint mechanism belonging there to. The type of solution in question is not very strongly built in practice particularly when keeping in mind its purpose, nor adequately reliable in use, either. The solution in question has furthermore such a bad problem that the armrests move too much down in the tilting movement i.e. clearly below the seat part, which is why a person standing up can not e.g. exploit his/her hand force till the end of the movement due to the armrests sinking from under.

Furthermore, one solution related to the theme at present has been presented in the international application publication WO 85/00006, in the solution according to which the seat part of the seat is arranged by a joint arm mechanism first of all to be tilted from a sitting-position to a standing up-position, where the seat part is inclined downward toward its front edge, and on the other hand to be lifted upward while being tilted to its standing up-position from the sitting position. In the solution in question there has been exploited furthermore at least partly independently functional driving means, operating by power that is directed to the seat part from the person sitting on the seat, the driving means comprising at least a locking assembly for locking the seat essentially immovably to its sitting-position and a releasing assembly for reinstating the movement function of the seat by releasing it from its sitting-position. In this solution the seat part gets locked immobilized when the person sits on the seat. Activating the releasing assembly of the seat takes place in such a manner that the sitting person simultaneously presses releasing buttons in connection with the handles of the chair in order to release the movement action of the chair and thereafter he/she pushes the ends of the handles downward while simultaneously moving him-/herself towards the front of the seat part.

The solution described above is unsuitable particularly for use of physically restricted and for people having poor motor coordination, because it requires an ability both to use simultaneously the releasing buttons in connection with the handles and additionally to push the handles downward together with a weight transfer forward when getting up from the seat.

A further developed solution with respect to the prior art described above is presented in the international publication WO 2011/141617, which is based on that that the simultaneous tilting and lifting movement of the seat part is carried out by a joint mechanism being carried out on a quadrangle joint-principle, the joint mechanism consisting of one or more pairs of articulated arms, the arms being articulated in connection with the seat part and turning in an essentially vertical plane, whereby the frontal articulated arm is shorter than the second articulated arm in order to bring about the simultaneous tilting and lifting movement of the seat part.

The above solution has been found very effective in practice in furthering both standing up of a person sitting on the seat and on the other hand also rehabilitation of a person e.g. by repeating successive standing up-movements. Particularly with a view to a situation, when a person settling down on a seat gets support from the seat, the seat may, however, swing, in case a too high force is directed thereto, which may make settling down on the chair much more difficult for the person. This is why, in certain situations, it is recommendable to take advantage of an assistant when using the chair, whereby the assistant keeps the chair in its sitting-position, until the person has finally managed to properly settle down on it.

It is an aim of the arrangement for use of a functional seat according to the present invention to achieve a decisive improvement in the problems described above and thus to raise essentially the level of prior art. In order to carry out this aim, the arrangement according to the invention is mainly characterized by what has been presented in the characterizing part of the independent claim related thereto.

As the most important advantages of the arrangement according to the invention may be mentioned the simplicity and efficiency of its structures and functioning, so that use of power of the person him-/herself using a seat provided with the arrangement according to the invention can be activated by a seat that operates safely in every respect. The above is particularly thanks to the fact that the seat part of the seat stays locked in its sitting-position even though a person that is settling down thereon takes support therefrom when moving onto the seat e.g. from a rollator or a wheel chair, without a risk for the seat to swing. The releasing assembly of the driving means of the arrangement according to the invention is arranged to operate automatically or in a so called independent manner by influence of the power directed to the seat part from the person sitting on the seat, in which case settling down on the seat by the person and standing up from the seat can be carried out without help from outsiders, making thus possible optimal activation of the person's own use of force.

Thanks to the quadrangle joint-principle being utilized as an advantageous application in the movement mechanism of the arrangement according to the invention, extra articulated arms and articulation points can be avoided, which results to a very firm and use durable structure particularly thanks to those from all over stationary articulation points. In this way, it is on the other hand made possible that, when a person stands up e.g. from a relatively low sitting base, the seat part lifts the person adequately upward in a way that angles between thighs, legs and hips get more profitable (larger), which furthers significantly standing up particularly of a person in a poor condition, especially thanks to the armrests remaining continuously high enough above the seat part.

The invention may furthermore be applied in a way that the driving means comprise a separately operable driving device for using the locking and the releasing assemblies, such as a foot and hand driven switch to be used by an assisting person.

Other advantageous embodiments of the arrangement according to the invention have been presented in the dependent claims related thereto.

In the following description the invention is illustrated in detail with reference to the appended drawings, in which

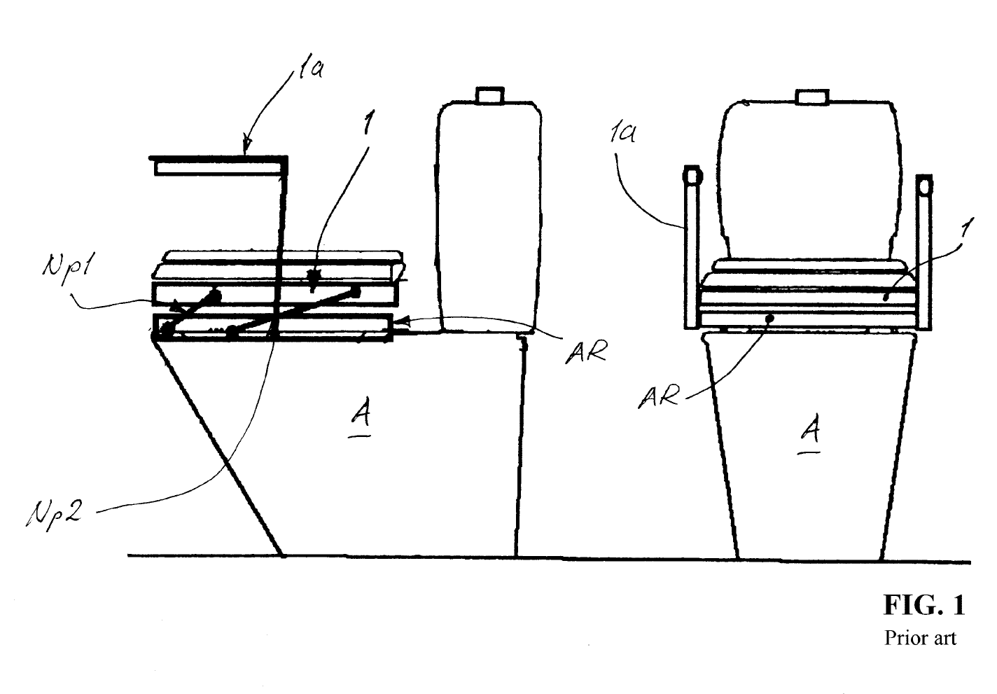

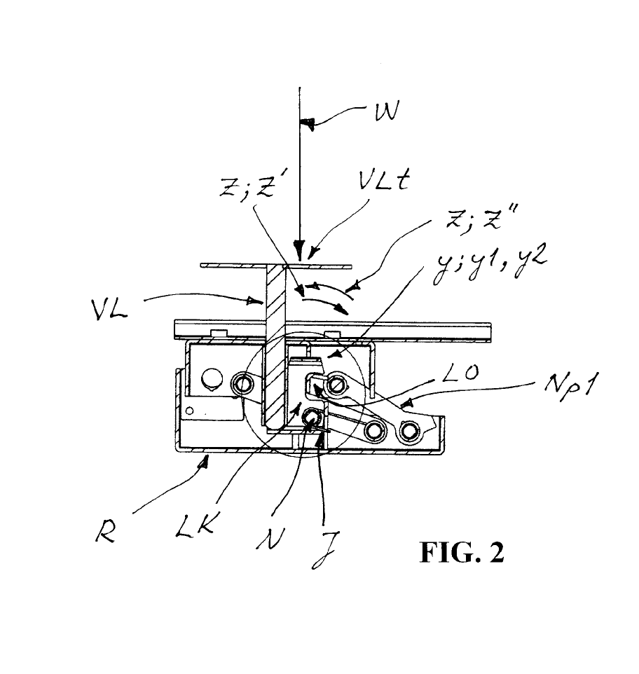

in FIG. 1 is shown as a side view and a front view an advantageous functional seat according to prior art being based on a quadrangle joint mechanism,

in FIG. 2 is shown as a side view an advantageous mechanical driving mechanism belonging to an application according to a first embodiment of the arrangement according to the invention,

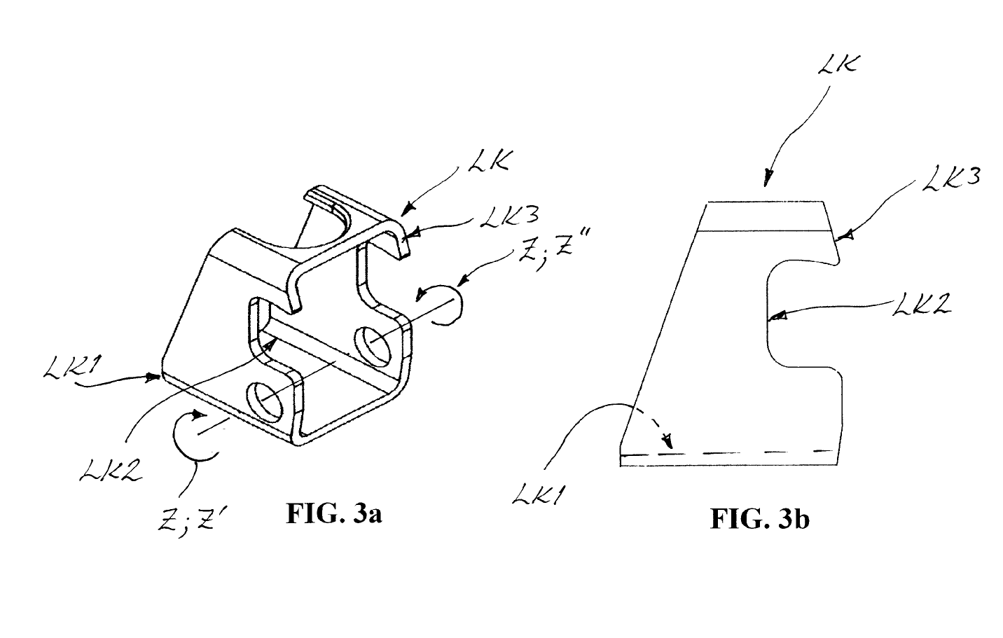

in FIGS. 3a and 3b is shown as a perspective view and as a side view an advantageous locking body being used in the application shown in FIG. 2,

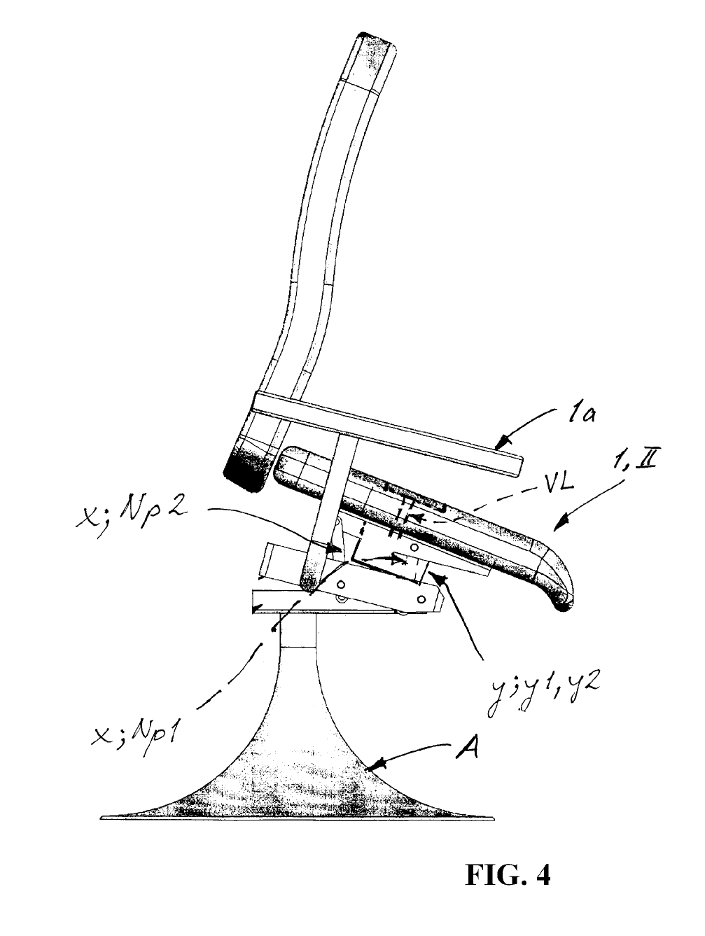

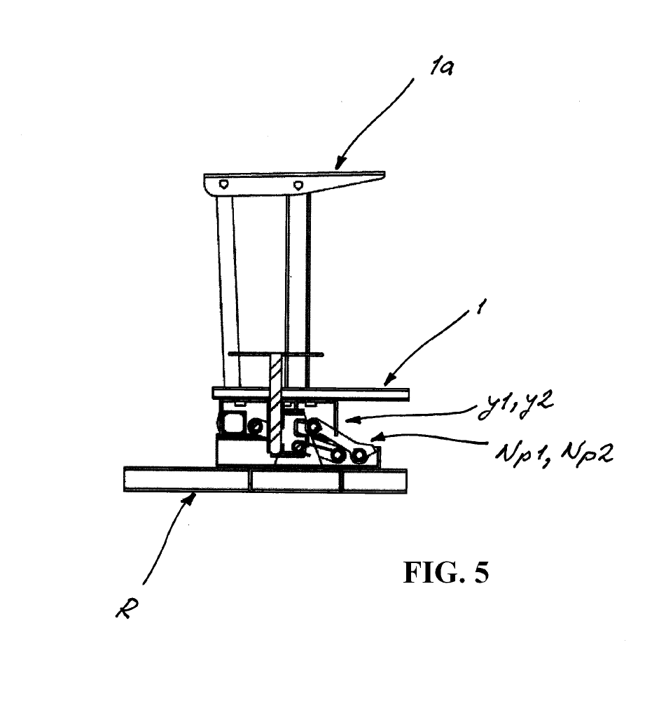

in FIG. 4 is shown a side view of a seat being provided with the arrangement according to the invention after a standing up-movement being carried out therewith,

in FIG. 5 is shown a partial side view of the driving mechanism according to FIG. 2 together with an armrest, seat part and a frame belonging to the arrangement,

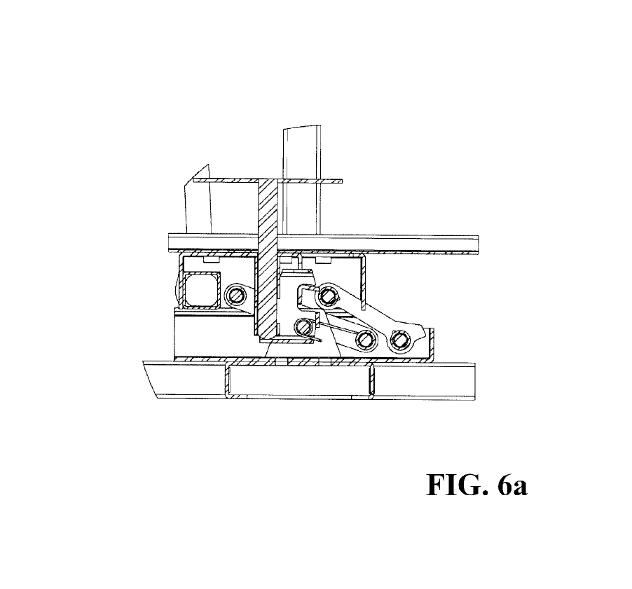

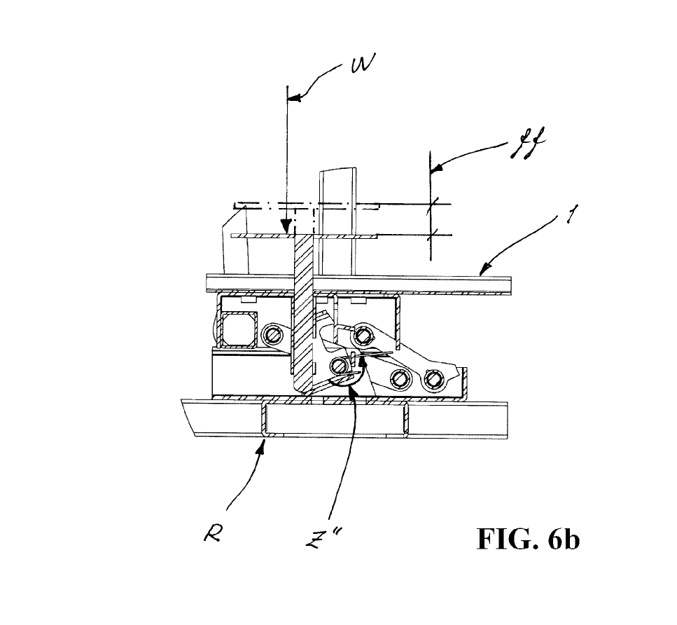

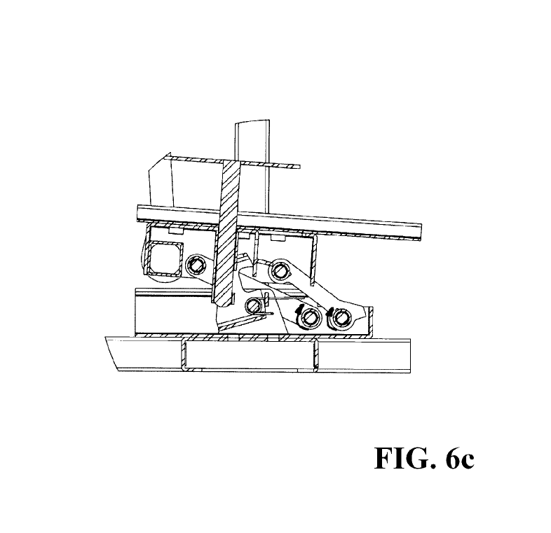

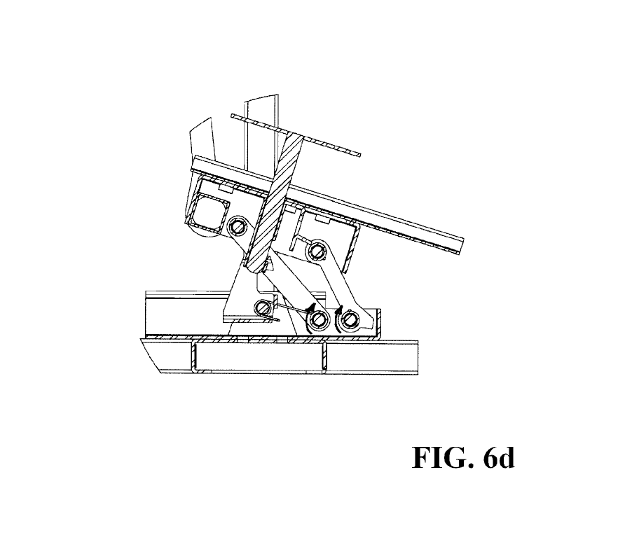

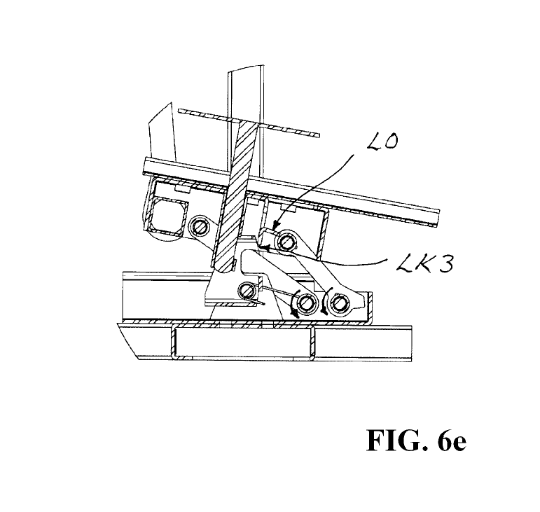

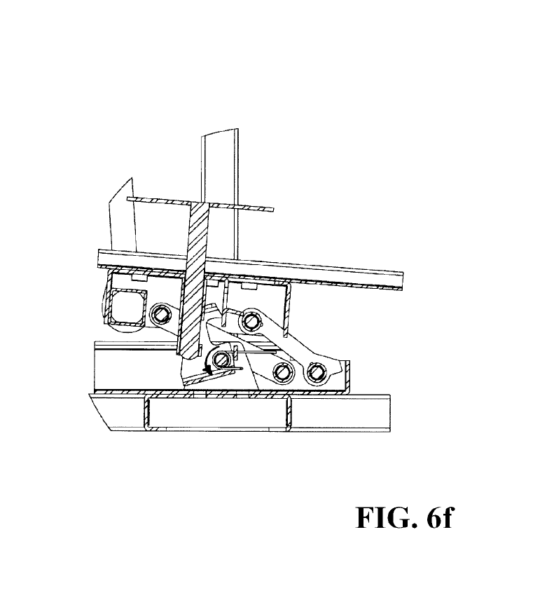

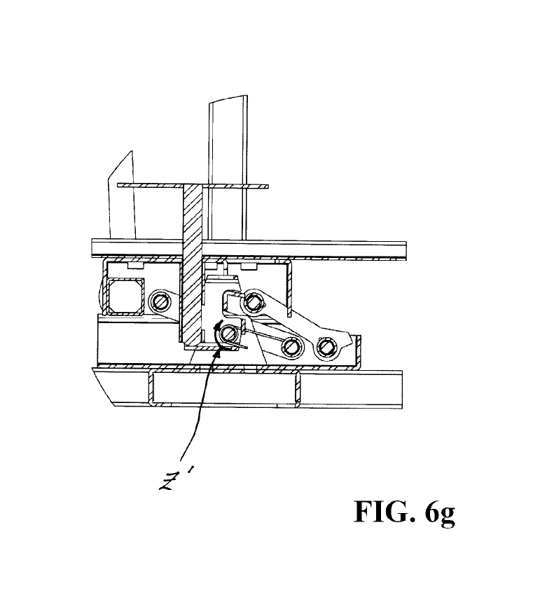

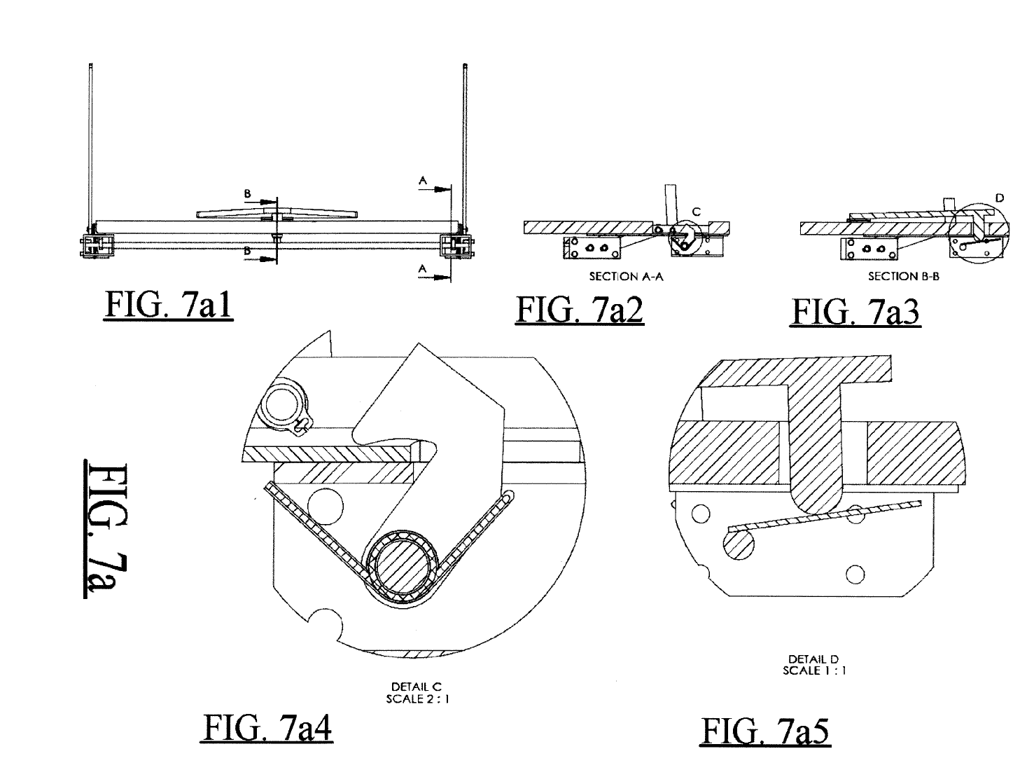

in FIGS. 6a-6g is shown the driving mechanism according to FIGS. 2 and 5 in different stages of the standing up- and downward-movements, and

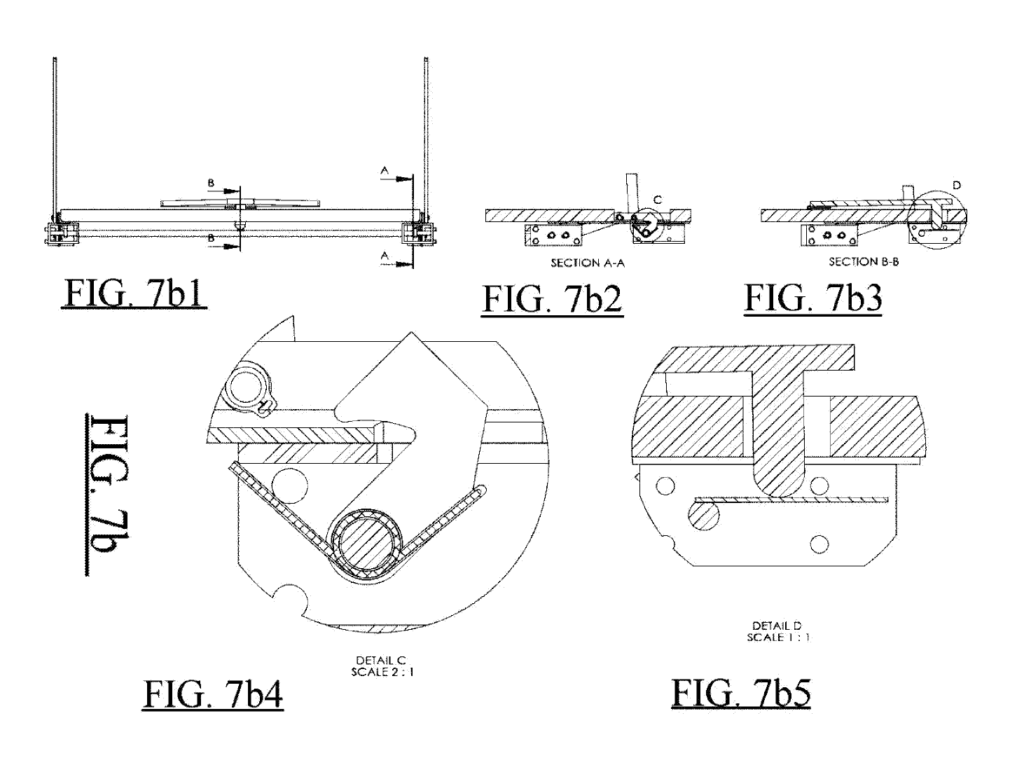

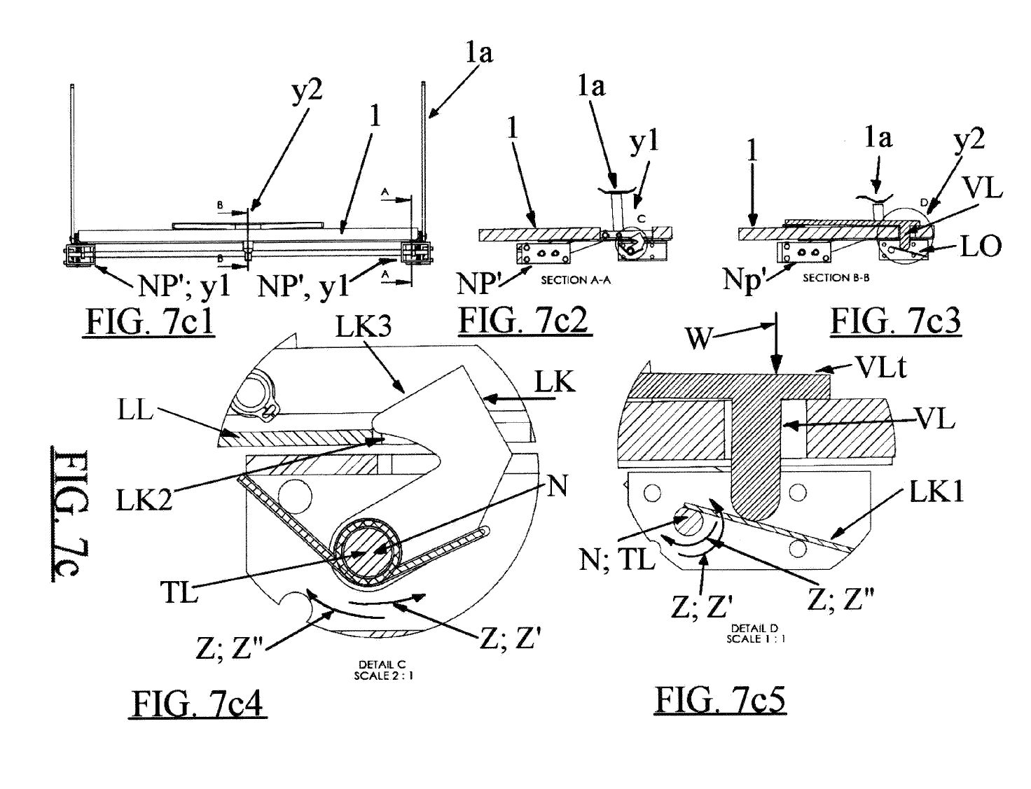

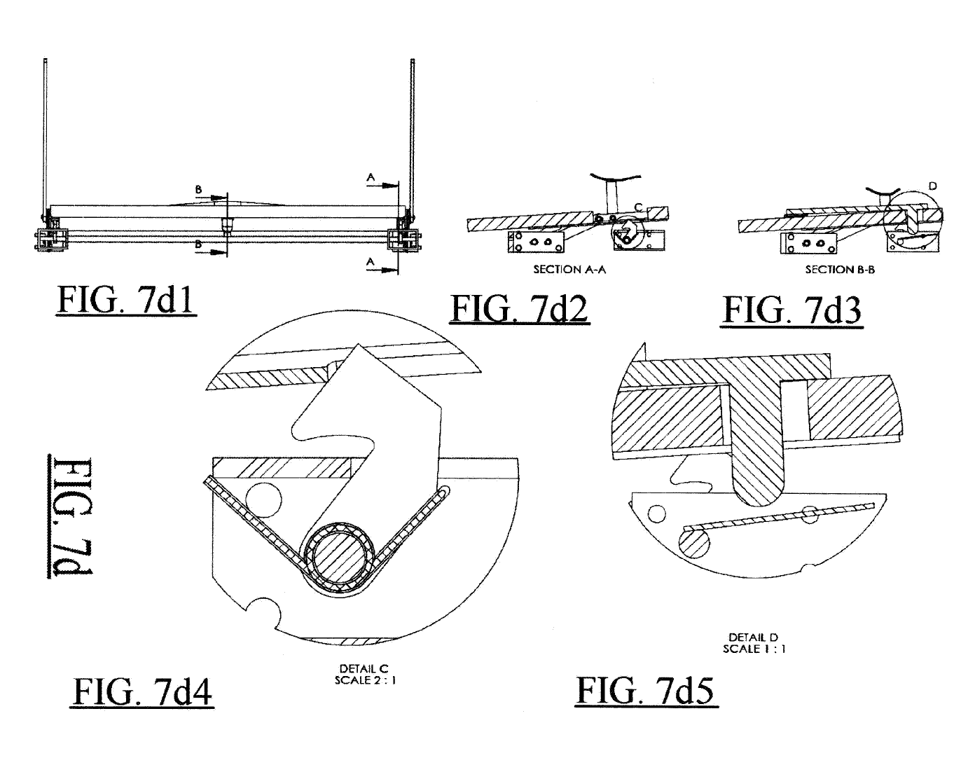

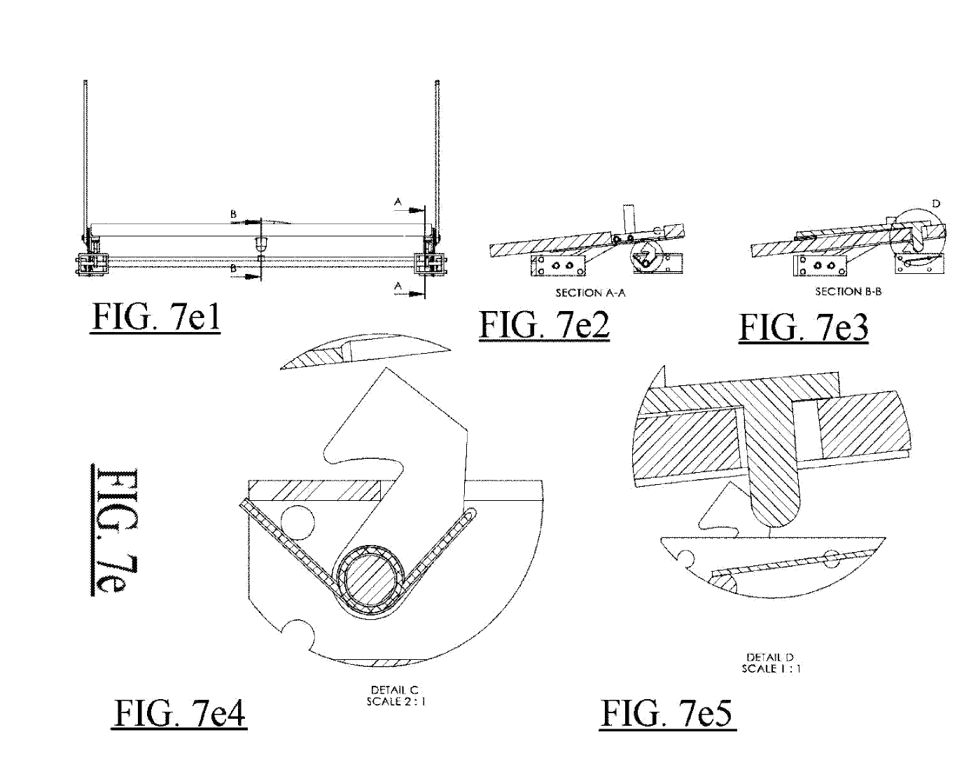

in FIGS. 7a-7e is shown as a series of images the operating principle of the second embodiment of the arrangement according to the invention in successive stages starting from releasing of the seat part's locking, whereby in each view in the series of images is shown a cross-sectional view of an entirety forming the arrangement (7a1-7e1), cross-sectional views from the points of the locking and releasing assemblies (7a2, 7a3-7e2, 7e3) and enlargements of the locking assembly and the releasing assembly (7a4, 7a5-7e4, 7e5).

The invention relates to an arrangement for use of a functional seat, which seat is intended particularly for assisting a person sitting thereon to stand up from a sitting position. The arrangement comprises a seat part 1 provided/to be provided in connection with a sitting base A and being coupled in a power transmitting manner with armrests la of the seat, wherein the seat part 1 is arranged by a movement mechanism x simultaneously on the other hand to incline from an essentially horizontal sitting-position I to a standing up-position II, where the seat part is inclined downward toward its front edge, and on the other hand to move upward while being inclined to the standing up-position II from the sitting-position I particularly in order to enable assisting a standing up-movement, preferably by influence of the person him-/herself sitting on the seat part 1, by exploiting his/her upper body through using hand force. The arrangement furthermore comprises at least partly independently functional driving means y, operating by power W that is directed to the seat part 1 from the person sitting on the seat, the driving means comprising at least a locking assembly y1 for locking the seat part essentially immovably to its sitting-position I and a releasing assembly y2 for reinstating the movement function of the seat part by releasing it from its sitting-position I. The releasing assembly y; y2 of the driving means is arranged to operate by influence of the power W directed to the seat part 1 from the person sitting on the seat in order to activate the movement function of the seat automatically when the person is sitting on the seat.

As an advantageous embodiment of the arrangement according to the invention, the movement mechanism x is arranged to operate at least partly through a power influence F directed downward from the armrests 1a, the movement mechanism x being carried out on quadrangle joint-principle, wherein it comprises at least one pair of articulated arms Np, being coupled in connection with the seat part in an essentially vertical plane turning manner and, in which, when viewed from the side from the front of the chair, a frontal articulated arm Np1 is shorter than the second articulated arm Np2 in order to bring about the simultaneous tilting and lifting movement of the seat part 1. The locking and releasing assemblies y; y1, y2 of the driving means are carried out by a mechanical driving mechanism y1, y2, such as operating on a lever arm or an eccentric principle, in a spring-loaded and/or the like manner.

The locking and/or releasing assemblies y1, y2 of the driving means y of the arrangement according to the invention have been advantageously carried out mechanically and/or by auxiliary power operated, such as electrical and/or pressure medium driven actuators. The driving means can be carried out in practice without external energy transmission e.g. electrically in an accumulator or micro-switch operated manner and in addition to or instead of the above also in a pressure medium operated manner, such as by pneumatically and/or hydraulically driven lifting/damping cylinders, pressure accumulators and switches etc. As the most advantageous starting point in practice in carrying out the arrangement according to the invention has been found to implement its functionings mainly by mechanical device solutions, advantageous implementations related to which have been described more accurately in the following.

In the advantageous application of a first embodiment of the arrangement according to the invention, being presented particularly in FIGS. 2-6e, the locking and releasing assemblies y1, y2 of the driving means y are carried out by a driving mechanism that is carried out in a built-in manner in connection with the pair of articulated arms Np, when instead in the advantageous application of a second embodiment presented in FIGS. 7a-7e, the locking assembly y1 and the releasing assembly y2 of the driving mechanism have been structurally separated from each other.

The locking and/or releasing actions of the arrangement according to the invention can be carried out also mechanically in very many ways by taking advantage of the operating principles described above.

In connection with mechanical implementations it is furthermore naturally possible in implementing certain functionings to exploit e.g. piezo electric micro switches and/or the like technique.

Furthermore as an advantageous application of the first embodiment of the arrangement, the built-in driving mechanism y1, y2 comprises particularly with reference to FIGS. 2 and 3a, 3b and 6a-6g a spring-loaded J locking body LK that is articulated N with the frame R of the driving mechanism y1, y2, which body has a releasing surface LK1 for locking, a locking recess LK2 and a guide surface LK3 for locking for its locking and releasing actions, which principle manifests itself also particularly in view 7c4 in FIG. 7c showing the second embodiment, in which particularly the releasing surface LK1 for locking with a view to its placement has been implemented structurally in a different manner.

Furthermore as an advantageous application of the first embodiment of the arrangement, a releasing means VL is coupled in connection with the locking body LK of the driving mechanism y1, y2, which releasing means as shown particularly in FIG. 6b by a power influence W directed thereto, in co-operation with the releasing surface LK1 for locking brings about a releasing movement z″ of the locking body LK in opposite direction with respect to its locking movement z′.

As a further advantageous application in this context particularly with reference to FIG. 2, the driving mechanism y1, y2 comprises a locking means, such as a locking projection LO, being arranged particularly in connection with a frontal articulated arm Np1 of the pair of articulated arms, which, when the articulated arms Np1, Np2 of the driving mechanism move downward particularly as shown in series of images 6a-6g, operates in co-operation (see figure 6e, 6f and 6g) with the locking recess LK2 and the guide surface LK3 that steers the locking, both of the above existing in the locking body LK. In the final stage according to FIG. 6g, when the locking projection LO has moved into the locking recess LK2 of the locking body, the spring-loaded locking body is free to perform its locking movement z′.

As a further advantageous embodiment particularly with reference to FIGS. 4 and 6b, the upper part VLt of the driving mechanism's y1, y2 releasing means VL is arranged above the seat part 1, in which case its vertical releasing movement ff is carried out by flexion assemblies between the said upper part and the seat part 1, e.g. by using a suitable flexible material, suspension/dampening between the said parts.

In FIGS. 7a-7e there has been presented an alternative second embodiment with respect to the first embodiment of the arrangement according to the invention described above, in which the locking assembly y1 and the releasing assembly y2 of the driving means have been structurally separated from each other first of all in a way that the movement mechanism x is carried out on the principle manifesting itself in FIGS. 7a1-7e1 to that the movement mechanism x is arranged when viewed in a crosswise direction by pairs of articulated arms Np′ existing at opposite ends of the seat part 1, in connection with which the locking body LK acting as the locking assembly y1 of the driving mechanism is coupled in a power transmitting manner.

In the second embodiment of the arrangement according to the invention, the locking assemblies y1, such as locking bodies LK, in connection with the pairs of articulated arms Np′ at opposite ends of the seat part 1, are coupled with each other by a rigid power transmission means TL, such as a pipe, a rod, a profile and/or the like, going essentially in crosswise direction. In this case the releasing means VL of the releasing assembly y2 is arranged as shown in FIGS. 7a5-7e5 to produce in co-operation with the releasing surface LK1 for locking, existing at a center part of the power transmission means, the releasing movement z″ of the locking body LK in opposite direction with respect to its locking movement z′ by rotating the power transmission means TL around its longitudinal axis as shown in FIGS. 7a4-7e4.

In the arrangement according to the invention it is important that the power, by means of which the locking of the driving means gets released e.g. as shown in FIGS. 6b and 7c3, is adequately high, so that it does not go off e.g. in a situation, when a person trying to settle down on the seat seeks for support when moving thereto e.g. from a rollator or a wheel chair. The magnitude of the power that releases the lifting up-movement of the seat is adjustable particularly in the mechanical driving mechanism of the first embodiment by using an adequately stiff/adjustable spring J in connection with the locking body LK and/or in addition to or instead of the above an efficiently enough retarding flexion assembly in connection with the seat part 1. For this purpose, it is possible to vary the device configuration belonging to the driving mechanism according to the needs at any given time also with mechanical, electric and/or pressure medium operated adjustment solutions that carry out the same effect and that are, when needed, accurately adjustable.

In this context, it is naturally possible to carry out the arrangement according to the invention instead of the embodiments described above or e.g. at least partly in addition to the same mechanically also at least partly assisted by auxiliary power, such as operated by a person who assists a standing up person by using a foot pedal operated e.g. by joint and/or spring mechanisms, and/or electrically by using a battery, an accumulator unit and/or mains current, or hydraulically/pneumatically by exploiting e.g. pressure of a compressed water/air supply etc. The type of applications described above have not, however, been presented in greater detail in the drawings.

As an example of one possible use of the arrangement according to the invention, in FIG. 1 is shown a functional WC-seat being carried out on quadrangle joint principle. In this type of application, the arrangement according to the invention may be implemented in a corresponding manner by driving means that are arranged in a movement mechanism, being coupled with a WC-seat by an auxiliary frame AR.

It is apparent that the invention is not limited to those previously presented or explained embodiments, but instead it can be modified within the basic idea of the invention in many ways depending e.g. on the sitting base in use at any given time, in connection with which the arrangement is being used. In the enclosed drawings there is not shown more closely fastening means for the connecting of the seat arrangement to a wheelchair or the like sitting base, because such implementations depend on the support system of the sitting base. In this respect, it is possible to carry out a seat structure provided with the arrangement according to the invention e.g. on quick release principle e.g. in order to make the connection thereof with a wheelchair quicker. It is also evident that the seat arrangement according to the invention can be used with what ever type of sitting base, when there is a need for assisting a person sitting thereon to stand up. One such use in a suitably modified manner could be e.g. a car seat, wherein it would furthermore be advantageous to provide the seat structure with a turning mechanism in order to enable turning of the sitting surface e.g. with an angle of 45-90° around a vertical axis.

1. An arrangement for use of a functional seat, which seat is intended particularly for assisting a person sitting thereon to stand up from a sitting position, wherein the arrangement comprises a seat part (1) provided/to be provided in connection with a sitting base (A) and being coupled in a power transmitting manner with armrests (1 a) of the seat, wherein the seat part (1) is arranged by a movement mechanism (x) simultaneously on the other hand to incline from an essentially horizontal sitting-position (I) to a standing up-position (II), where the seat part is inclined downward toward its front edge, and on the other hand to move upward while being inclined to the standing up-position (II) from the sitting-position (I) particularly in order to enable assisting a standing up-movement, preferably by influence of the person him/herself sitting on the seat part (1), by exploiting his/her upper body through using hand force, and, wherein the arrangement furthermore comprises at least partly independently functional driving means (y), operating by power (W) that is directed to the seat part (1) from the person sitting on the seat, the driving means comprising at least a locking assembly (y1) for locking the seat part essentially immovably to its sitting-position (I) and a releasing assembly (y2) for reinstating the movement function of the seat part by releasing it from its sitting-position (I), characterized in that, the releasing assembly (y; y2) of the driving means is arranged to operate by influence of the power W directed to the seat part 1 from the person sitting on the seat in order to activate the movement function of the seat automatically when the person is sitting on the seat.

2. Arrangement according to claim 1, wherein the movement mechanism (x) is arranged to operate at least partly through a power influence (F) directed downward from the armrests (1a), the movement mechanism (x) being carried out on quadrangle joint-principle, wherein it comprises at least one pair of articulated arms (Np), being coupled in connection with the seat part in an essentially vertical plane turning manner and, in which, when viewed from the side from the front of the chair, a frontal articulated arm (Np1) is shorter than the second articulated arm (Np2) in order to bring about the simultaneous tilting and lifting movement of the seat part (1), characterized in that, the locking and releasing assemblies (y; y1, y2) of the driving means are carried out by a mechanical driving mechanism (y1, y2), such as operating on a lever arm or an eccentric principle, in a spring-loaded and/or the like manner.

3. Arrangement according to claim 1, characterized in that, the driving mechanism (y1, y2) comprises a spring-loaded (J) locking body (LK) that is articulated (N) to rotate (z) in a vertical plane and which has a releasing surface (LK1) for locking, a locking recess (LK2) and a guide surface (LK3) for locking for its locking and releasing actions.

4. Arrangement according to claim 1, characterized in that, a releasing means (VL) is coupled in a power transmitting manner in connection with the locking body (LK) of the driving mechanism (y1, y2), which releasing means by a power influence (W) directed thereto in cooperation with a releasing surface (LK1) for locking, being coupled at least in a power transmitting manner with the locking body (LK), brings about a releasing movement (z″) of the locking body (LK) in opposite direction with respect to its locking movement (z′).

5. Arrangement according to claim 1, characterized in that, the driving mechanism (y1, y2) comprises a locking means, such as a locking projection (LO), being arranged in connection with a frontal articulated arm (Np1) of the pair of articulated arms, or a locking plate (LL) coupled with the seat part (1), which operates in co-operation with a locking recess (LK2) and a guide surface (LK3) that steers the locking, both of the above existing in the locking body (LK).

6. Arrangement according to claim 1, characterized in that, an upper part (VLt) of the driving mechanism's (y1, y2) releasing means (VL) is arranged above the seat part (1) in order to enable its vertical releasing movement (ff).

7. Arrangement according to claim 1, characterized in that, the movement mechanism (x) is arranged when viewed in a transverse direction by mechanisms formed of pairs of articulated arms (Np') that exist at opposite ends of the seat part (1), in connection with which the locking body (LK) of the driving mechanism is coupled in a power transmitting manner.

8. Arrangement according to claim 7, characterized in that, the locking assemblies (y1), such as locking bodies (LK), in connection with the pairs of articulated arms (Np′) at opposite ends of the seat part (1) are coupled with each other by a rigid power transmission means (TL), such as a pipe, a rod, a profile and/or the like, going essentially in crosswise direction.

9. Arrangement according to claim 8, characterized in that, the releasing means (VL) of the releasing assembly (y2) is arranged to produce in cooperation with a releasing surface (LK1) for locking that exists at a center part of the power transmission means the releasing movement (z″) of the locking body (LK) in opposite direction with respect to its locking movement (z′) by rotating the power transmission means (TL) around its longitudinal axis.

10. Arrangement according to claim 1, characterized in that, the driving means (y) comprise a separately operable driving device for using the locking and/or the releasing assemblies (y1, y2), such as a foot and/or hand driven switch or like to be used by an assisting person.

11. The arrangement according to claim 1, wherein of the driving means is configured to reinstate the movement function of the seat part when the person sits down on the seat by influence of the power (W) directed to the seat part (1) from the person.
